(19) United States
(12) Patent Application Publication
(10) Pub. No.: US 2026/0009597 A1
(43) Pub. Date: Jan. 8, 2026

(54) SAFETY HEAT EXCHANGER AND METHOD FOR THE PRODUCTION OF A SAFETY HEAT EXCHANGER

(71) Applicant: Kelvion Machine Cooling Systems GmbH, Herne (DE)

(72) Inventor: Stefan Ziegler, Sprockhövel (DE)

(73) Assignee: Kelvion Machine Cooling Systems GmbH, Herne (DE)

(21) Appl. No.: 19/261,577

(22) Filed: Jul. 7, 2025

(30) Foreign Application Priority Data
Jul. 8, 2024 (DE) 10 2024 119 372.7

(51) Int. Cl. F28F 1/02; B23P 15/26

(52) U.S. Cl. CPC F28F 1/022; B23P 15/26

(57) ABSTRACT

A safety heat exchanger includes a first flow channel for a first medium, a second flow channel separated from the first flow channel by a double wall for a second medium, said double wall including a first wall and a second wall which delimit a leakage space between them, and an open-pored metal foam arranged in the leakage space and contacting the first and second walls.

### CROSS-REFERENCES TO RELATED APPLICATIONS

This application claims the priority of German Patent Application, Serial No. 10 2024 119 372.7, filed Jul. 8, 2024, pursuant to 35 U.S.C. 119 (a)-(d), the disclosure of which is incorporated herein by reference in its entirety as if fully set forth herein.

### BACKGROUND OF THE INVENTION

The invention relates to a safety heat exchanger and to a method for the production of a safety heat exchanger.

The following discussion of related art is provided to assist the reader in understanding the advantages of the invention, and is not to be construed as an admission that this related art is prior art to this invention.

Heat exchangers/heat exchangers have the task of carrying out a thermal coupling between a primary circuit and a secondary circuit without an exchange of media taking place. In heat exchangers, however, material fatigue, pressure fluctuations or pressure surges as well as changing thermal loads can cause damage to the structure, e.g. in the form of plate or tube fractures. One approach to prevent contamination in the primary circuit or secondary circuit, involves the use of safety heat exchangers with double walls. The double wall is intended to delimit a leakage space which is monitored by a pressure sensor for example. The disadvantage of this design is that the leakage space is normally filled with a gas, with gases having a much lower thermal conductivity than metals and virtually acting as an insulator. Therefore, for example, adjacent plates of a plate heat exchanger are also partially brought into metallic contact in the leakage space. Soldering would lead to structural changes and possibly to the formation of weak points, the absence of a connection between the adjacent plates would, however, cause the plates to deform under the pressure of the media. However, no leakage can be detected at the connections, so that the area occupied by the connections may not be too large. As a result, there is a conflict of objectives between the desired high level of safety against contamination of the media on the one hand and good heat transfer and high load-bearing capacity on the other hand.

It would therefore be desirable and advantageous to provide an improved safety heat exchanger and a method for the production of such a safety heat exchanger to obviate prior art shortcomings and to enable improved heat transfer and a high level of operational safety at the same time.

### SUMMARY OF THE INVENTION

According to one aspect of the present invention, a safety heat exchanger includes a first flow channel for a first medium, a second flow channel separated from the first flow channel by a double wall for a second medium, with the double wall including a first wall and a second wall which delimit a leakage space between them, and an open-pored metal foam arranged in the leakage space and contacting the first and second walls.

The open-cell metal foam is intended to connect the first and second walls and is used for heat transfer. The provision of the open-cell metal foam significantly improves heat transfer as a consequence of having a large surface area that comes into contact with the walls. The leakage space assumes the function to keep the first and second media separate from each other in the event of a defect in one of the walls and to create the possibility of detecting leakage. In the simplest case, detection can be realized through visual inspection by checking whether a medium is escaping from the leakage space, for example whether a liquid is escaping from the bottom of a plate heat exchanger with vertically arranged plates. As an alternative, a parameter prevailing in the leakage space can be monitored, e.g. the pressure. A rise in pressure in the leakage space to the pressure of the first or second medium indicates the presence of a leakage to the first or second medium.

The metal foam is open-pored so that the medium can be detected during a visual inspection in the event of a leakage or an accompanying increase in pressure can be detected. The metal foam has such an open-pored structure that at least some of the pores of the metal foam on a side of the heat exchanger remote from a leakage test position communicate with at least some of the pores adjacent to the leakage test position.

The open-pored metal foam increases the metal portion within the leakage space and significantly improves heat transfer. Assuming that in a plate heat exchanger, for example 50% of the surface area of one wall is metallically connected to the other wall by soldering, heat transfer in this 50% of the surface area while being very good, enables detection of a leakage in this 50% of the surface area only when the leakage breaks through into the area that has not been connected by soldering. Leakage is thus only detected late.

According to the invention, an open-pored metal foam is advantageously connected to the first and second walls by more than 50% to establish a heat transfer through metallic contact over more than 50% of the surface area. At the same time, the structure of the foam is more delicate than large-area solder contact points. When the metal foam has fine pores, leakage can be detected earlier than with walls that are soldered together in some areas. A further advantage is that the walls or plates no longer need to be profiled or no longer need to be profiled as much when using a metal foam, but are predominantly smooth. Manufacturing costs for producing the walls can be significantly decreased.

According to another advantageous feature of the invention, the metal foam can have a maximum pore size which is smaller than a distance between the first and second walls. In the case of pores with a maximum pore diameter that is greater than a distance between the walls, a higher local gas content could be present in the leakage space and heat transfer would be less homogeneous, which not only adversely affects efficiency, but could also generate thermal stress within the individual walls. The maximum pore diameter is advantageously in a range below 80%, in particular below 50% of the distance between the walls. When the distance between the walls varies, the greatest distance between the walls is crucial.

According to another advantageous feature of the invention, the safety heat exchanger can be designed as a double-tube safety heat exchanger or as a plate safety heat exchanger. Double-tube safety heat exchangers include a double-walled inner tube arranged within an outer tube. The double wall is cylindrical. The cylindrical shape allows the inner tube to be expanded so that good thermal contact can be achieved even without a material bond.

In plate safety heat exchangers, embossed double plates are normally used, which are in thermally conductive contact at their contact points and, in particular, connected to each other with a material bond, e.g. soldered. The double wall may also involve walls of a sealed or bolted plate heat exchanger. Sealed plate heat exchangers have improved cleaning options because the heat exchanger plates are not connected to each other by a material bond.

The advantages of the invention not only reside in the fact when arranging an open-pored metal foam in the leakage space, but also when the first wall and/or the second wall has projections via which the first and second walls are in metallic contact, with the metal foam being arranged between the neighboring projections. As a result, conventional safety heat exchangers, whether in the form of a double safety heat exchanger or a plate safety heat exchanger, can be optimized by open-pored metal foams in the leakage space. When assuming, for example, in case of plate heat exchangers that 50% of the surface area of the walls is connected to the other wall through direct contact or material bonding, e.g. by soldering the projections, the presence of an additional metal foam in the areas between the projections contributes to a significant increase in the metal portion in the leakage space, so that heat transfer is also significantly improved.

Regardless as to whether projections are arranged between the first and second walls, according to another advantageous feature of the invention, a volume of the metal portion between the first and second walls can be in a range of more than 50 to 95%, in particular in a range of 60 to 90%. Currently preferred is a volume of the metal portion in the range of 80 to 90%. Conversely, as a result the volume proportion of the pores can be advantageously less than 40%. Currently preferred is a volume proportion of the pores of less than 15% to thereby significantly improve thermal conductivity compared to safety heat exchangers with a lower metal portion in the leakage space. In contrast to other applications of metal foams, weight saving due to the pores is of no concern here, but rather the fact that the metal foam is used for thermal improvement without being exposed to flow due to its larger surface area. From a thermal point of view, it is not the pores that are relevant, but the webs between the pores that connect the walls thermally and mechanically. From a safety point of view, the pores should be evenly dispersed so that all areas of the leakage space can be safely monitored.

The volume specifications for the metal portion refer both to embodiments in which only an open-pored metal foam is arranged in the leakage space and to leakage spaces that are additionally delimited by projections of one or the other wall.

In the case of double-tube safety heat exchangers, the inner tube or the first wall may have outward-facing ribs or projections. It is also possible to use a smooth tube as the inner tube, which is combined with an internally profiled outer tube that is guided over the smooth tube. In this case, profiling of the outer tube is in metallic contact with the inner tube in order to improve heat transfer. The areas between the profiling can be filled with the metal foam.

According to another aspect of the invention, a method for producing a safety heat exchanger includes providing a double wall to separate a first flow channel for a first medium from a second flow channel for a second medium and to delimit a leakage space, and arranging an open-pored metal foam in the leakage space between a first wall and a second wall of the double wall such as to contact the first and second walls.

The double wall may be a double wall in a double-tube safety heat exchanger or in the form of a plate safety heat exchanger. The double wall defines a gap-shaped leakage space with its first and second walls. The open-pored metal foam is placed into this leakage space such as to contact the first wall and the second wall. Introducing a metal foam is comparatively simple. In a first embodiment, a flowable metal particle paste, e.g. a metal-filler mixture, can be introduced to fill the leakage space and subsequently pores are produced in the metal particle paste through thermal or chemical treatment. A thermal treatment may involve, for example, application of a pore-forming propellant to cause foaming of the metal matrix and thereby form the pore structure. A solvent can be used to chemically remove non-metal components from the metal particle paste or from the metal foam. Fillers in the paste can be melted out or chemically removed. In a further step, the remaining metal matrix can be sintered and hardened. At the same time, neighboring plates are connected together.

In the case of a flowable metal particle paste with a filler, a filler may advantageously be used, or a thermal or chemical treatment of the filler, with which a maximum pore size of the metal foam can be adjusted that is smaller than the distance between the walls. A fine-pored and at the same time open-pored metal foam thus has many webs and intersections at the pores that can transfer heat. The finer the pores, the greater the metal portion and the better the heat transfer. At the same time, the walls of the double wall are connected to each other. They are mutually supported by the open-pored metal foam. The metal foam prevents the flow channels from deforming towards the leakage space at high pressures, especially in plate safety heat exchangers. The open-pored and flat metal foam prevents the plates from expanding. By using the metal foam, it is possible to reduce the number of material bonds or completely eliminate the need for material bonds between neighboring walls of a leakage space.

As an alternative, the metal foam can be provided as a flat body, e.g. as a film or mat, comparable to an open-pore filter fleece or wire mesh. The flat body is prefabricated. The flat body can be planar or have a curved shape, e.g. a cylindrical segment or even tubular. Such a flat body can already be sintered before it is inserted into the leakage space. The flat body can then be pressed in order to create or improve the metallic contact with adjacent surfaces. This embodiment is particularly suitable for use with sealed/bolted safety plate heat exchangers.

According to another advantageous feature of the invention, the metal foam in the leakage chamber can have a volume proportion in a range from 50 to 95%, in particular a range from 60 to 90%. Currently preferred is a volume proportion of above 85%.

Copper or a copper alloy is advantageously used as the metal for the metal foam. Copper has a very high thermal conductivity and is easy to process. For soldered safety heat exchangers, it can be advantageous to use for the metal foam a base material that has a melting point above the melting point of the soldering material. When using copper as the soldering material, steel or stainless steel or other alloys with a higher melting point, such as e.g. Ni alloys, could be suitable. Due to the different melting points, the metal foam is not damaged during soldering.

In summary, a safety heat exchanger according to the invention with a metal foam component in the leakage space exhibits significantly better properties in terms of heat transfer than comparable designs without metal foam in the leakage space, without compromising safety. The metal foam is easy to install in terms of process technology, is highly resilient, serves to dampen vibrations and contributes to a reduction or even elimination of material-weakening solder joints between neighboring plates in the leakage space. Service life of a safety heat exchanger is improved. A suitable metal particle paste, which contains a metal powder mixed with a filler or a propellant, or a powdery mixture containing metal particles and mixed with a filler or propellant, is introduced into the leakage space, advantageously blown-in/injected/pressed-in, and can be extruded by subsequently heating the pre-material and create an open-porous structure that enables reliable leakage detection while at the same time realizes good mechanical and thermal stability. As an alternative, flat molded bodies can be used, which are pre-sintered for example.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross-section through flow channels of a first embodiment of a safety heat exchanger;

FIG. 1a is an enlarged detailed view of the area encircled in FIG. 1;

FIG. 2 is a cross-section through flow channels of a second embodiment of a safety heat exchanger;

FIG. 2a is an enlarged detailed view of the area encircled in FIG. 2;

FIG. 3 is a cross-section of a further embodiment of a safety heat exchanger in the form of a plate-type safety heat exchanger; and

FIG. 4 is a cross-section of still a further embodiment of a safety heat exchanger in the form of a plate-type safety heat exchanger.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

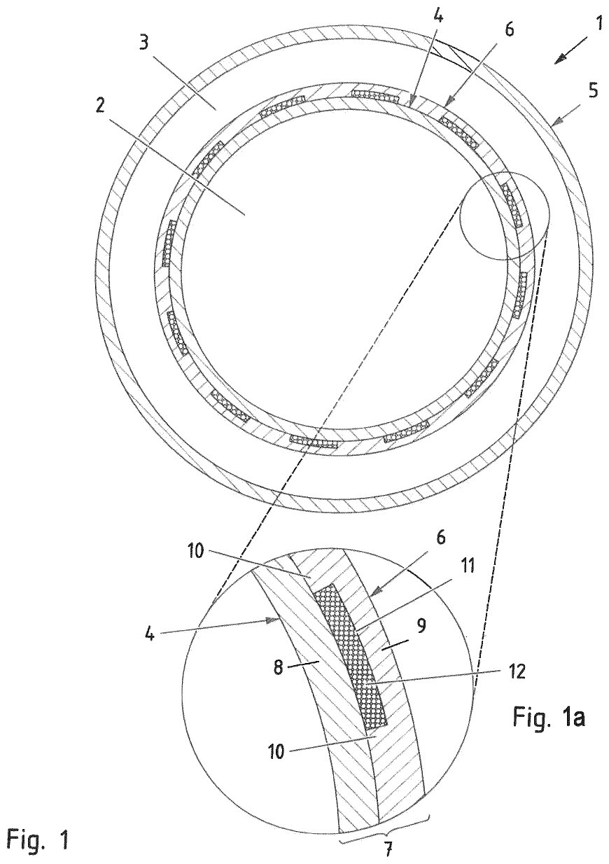

Turning now to the drawing, and in particular to FIG. 1, there is shown a cross-section through flow channels of a first embodiment of a safety heat exchanger, generally designated by reference numeral 1 and constructed in the form of a double-tube safety heat exchanger. The safety heat exchanger 1 has a first central flow channel 2 for a first medium and a second flow channel 3 for a separate second medium so that no contamination may occur between the first and second media. The first flow channel 2 is located in an inner tube 4. The second flow channel 3 is located in an annular space between the inner tube 4 and an outer tube 5, which surrounds the inner tube 4 at a radial distance. The two flow channels 2, 3 are not only separated from each other by the inner tube 4, but also by a further tube 6, which is arranged between the inner tube 4 and the outer tube 5. The inner tube 4 and the further tube 6 together form a double wall 7, with the inner tube 4 acting as the first wall 8 of the double wall 7 and the further tube 6 acting as the second wall 9.

FIG. 1a is an enlarged detailed view of the area encircled in FIG. 1 and shows that the first and second walls 8, 9 of the double wall 7 are partly in direct metallic contact, because the second wall 9 has a varying wall thickness. The further tube 6 has several plateau-like inwardly pointing projections 10 which form webs that run in longitudinal direction of the further tube 6. In addition, the projections 10 can also be metallically connected to the outside of the inner tube 4 in their radially inner areas, in particular soldered or otherwise materially connected, or pressed or otherwise form-fittingly connected.

A leakage space 11 is arranged between neighboring projections 10 and filled with an open-pored metal foam 12. The open-pored metal foam 12 fills the entire leakage space 11 so as to contact the first and second walls 8, 9. In this exemplified embodiment, only the area filled with metal foam 12 is referred to as leakage space 11. In functional terms, the area occupied by the projections 10 is also part of the leakage space, as the projections bridge the gap between the inner tube 4 and the neighboring further tube 6 on the outside.

In this exemplified embodiment, the open-pored metal foam 12 has a uniform pore distribution of its open pores. The pores each have a maximum pore size that is smaller than the distance between the first and second walls 8, 9 measured in the radial direction. In principle, the pores can be evenly or unevenly distributed. Solely for ease of illustration, FIGS. 1 and 1a depict a uniform pore size. The pores may, of course, also vary in size.

In particular, the volume proportion of the metal in the metal foam 12 is greater than 50%, in particular greater than 60%. Currently preferred is a volume proportion of the metal in the metal foam of greater than 80%. If the volume proportion of the metal in the leakage space is to be understood in such a way that projections on the walls are also included in the metal portion, then the volume proportion is advantageously greater than 75%, in particular greater than 80%.

The metal portion of the metal foam is always less than 100%. There must be a sufficient number of pores to detect the first or second medium from the flow channels 2, 3 when it breaks through into the leakage space 11.

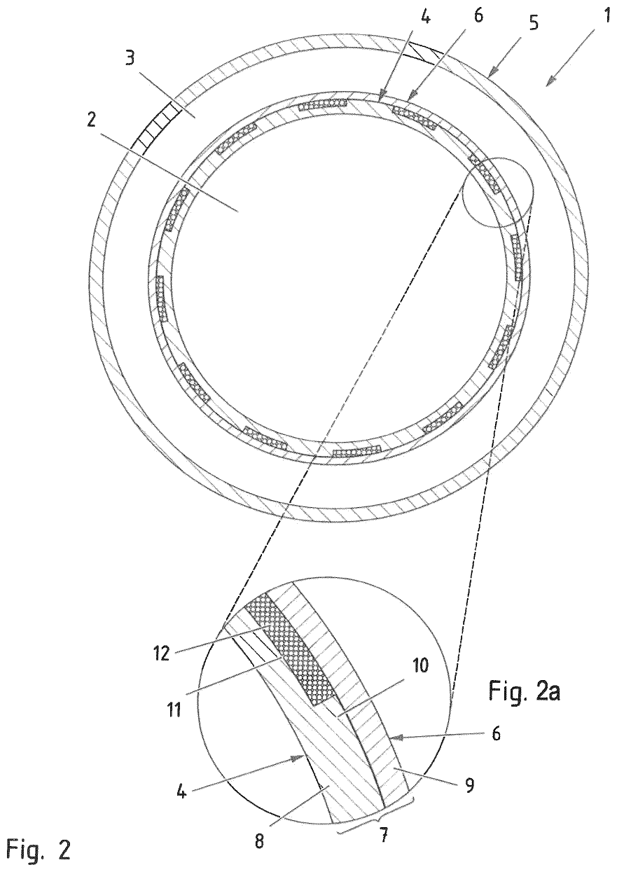

FIG. 2 is a cross-section through flow channels of a second embodiment of a safety heat exchanger. Parts corresponding with those in FIG. 1 are denoted by identical reference numerals and not explained again. The description below will center on the differences between the embodiments. In this embodiment, the projections 10 are arranged on the inner tube 4, as depicted in particular by the enlarged detailed view of FIG. 2a. The functional principle of the safety heat exchanger 1 in FIG. 2 is identical to that in FIG. 1. An open-pored metal foam 12 is arranged in the leakage space 11 between adjacent projections 10.

It will be understood by persons skilled in the art that the shape of the inner or outer profiling of the inner tube 4 or the further tube 6 is purely exemplary. The invention relates in a same way to safety heat exchangers in which the inner tube 4 and the further tube 6 are each smooth tubes and delimit an annular leakage space which is uninterrupted in the circumferential direction, without inwardly or outwardly projecting projections protruding into the leakage space 11.

FIGS. 1 and 2 show a double-tube safety heat exchanger with a central tube. The tube can be part of a central tube safety heat exchanger or a double tube bundle of a tube bundle heat exchanger.

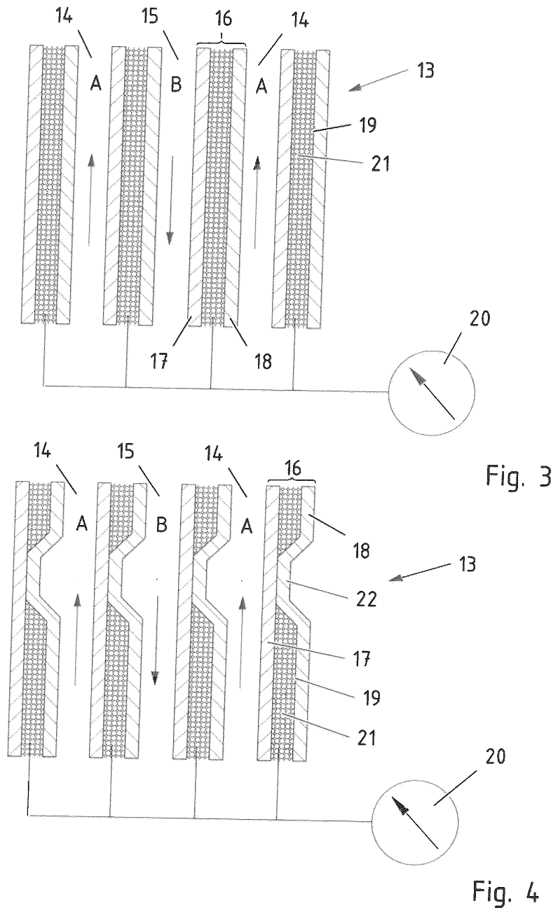

FIGS. 3 and 4 show alternative embodiments of a safety heat exchanger, generally designated by reference numeral 13 and designed in the form of a plate safety heat exchanger. The safety heat exchanger 13 depicted in FIG. 3 has a first flow channel 14 for a first medium A and a second flow channel 15 for a second medium B. In a layered design, this arrangement is repeated by alternating first and second flow channels 14, 15.

Arranged between the adjacent first and second flow channels 14, 15 is a double wall 16 with a first wall 17 and a second wall 18. The walls 17, 18 run parallel to each other and define a leakage space 19 between them. All leakage spaces 19 are connected to a pressure sensor 20. When the first medium A or the second medium B breaks through the double wall 16, the respective medium A or B flows into the leakage space 19. A pressure increase is then indicated at the pressure sensor 20.

The individual leakage spaces 19 are completely filled with an open-pored metal foam 21. The metal foam 21 connects the first and second walls 17, 18 of the double wall 16 with each other. As a result, the walls 17, 18 are supported against each other. The heat transfer in the leakage space 19 from the first wall 17 to the second wall 18 is improved by the metal foam 21. The open porosity of the metal foam 21 makes it possible to detect leakages over the entire inner surface of the leakage space 19 in the area of the first and second walls 17, 18.

The design shown in FIG. 3 does not have any additional projections on one of the walls 17, 18. The walls 17, 18 support each other via the open-pored metal foam 21. This stabilizes the individual flow channels 14, 15.

In the alternative embodiment shown in FIG. 4, projections 22 are formed on the second wall 18, via which the second wall 18 is in direct metallic contact with the first wall 17, without the interposition of an open-pored metal foam. However, the projection 22 is only located in a locally small area and serves to stiffen the double wall 16. Gaps between the individual projections 22 are filled with the open-pored metal foam 21, as in the embodiment shown in FIG. 3.

The representation of the metal foam 21 in FIGS. 3 and 4 is also purely exemplary. A maximum pore size should be smaller than the distance between the first and second walls 17, 18. The metal foam 21 should be sufficiently fluid-permeable with regard to its open pores so that even a leakage at the maximum distance from the pressure sensor 20 can be reliably detected. The metal foam 21 is not intended to block the leakage space 19, but rather is designed to enable a local increase in pressure to affect the entire area filled with metal foam 21, so that the pressure in all open pores of the metal foam 21 rises or drops evenly. The leakage space 19 can be subjected to a test at regular intervals through pressurization.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A safety heat exchanger, comprising:
a first flow channel for a first medium;
a second flow channel separated from the first flow channel by a double wall for a second medium, said double wall including a first wall and a second wall which delimit a leakage space between them; and
an open-pored metal foam arranged in the leakage space and contacting the first and second walls.

2. The safety heat exchanger of claim 1, wherein the metal foam has a maximum pore size which is smaller than a distance between the first and second walls.

3. The safety heat exchanger of claim 1, designed as a double-tube safety heat exchanger or as a plate safety heat exchanger.

4. The safety heat exchanger of claim 1, wherein at least one of the first wall and the second wall includes projections via which the first and second walls are in metallic contact, said metal foam being arranged between the projections.

5. The safety heat exchanger of claim 1, wherein the metal foam between the first and second walls includes a metal portion of a volume in a range from 50 to 95%.

6. The safety heat exchanger of claim 1, wherein the metal foam between the first and second walls includes a metal portion of a volume in a range from 60 to 90%.

7. A method for producing a safety heat exchanger, the method comprising:
providing a double wall to separate a first flow channel for a first medium from a second flow channel for a second medium and to delimit a leakage space; and
arranging an open-pored metal foam in the leakage space between a first wall and a second wall of the double wall such as to contact the first and second walls.

8. The method of claim 7, further comprising:
introducing a flowable metal particle paste into the leakage space; and
sintering the metal particle paste to form the metal foam.

9. The method of claim 7, wherein the metal foam has a form of a flat body and is introduced into the leakage space.

10. The method of claim 7, wherein the metal foam has a maximum pore size which is smaller than a distance between the first and second walls.

11. The method of claim 7, wherein the metal foam in the leakage space has a volume in a range from 50 to 95%.

12. The method of claim 7, wherein the metal foam in the leakage space has a volume in a range from 60 to 90%.
